(19) United States
(12) Patent Application Publication
(10) Pub. No.: US 2009/0210937 A1
(43) Pub. Date: Aug. 20, 2009

(54) CAPTCHA ADVERTISING

(76) Inventors: Alexander KRAFT, Cologne (DE); Michael KEFERSTEIN, Cologne (DE)

Correspondence Address: HARNESS, DICKEY & PIERCE, P.L.C., P.O. BOX 828, BLOOMFIELD HILLS, MI, 48303, US

(21) Appl. No.: 12/031,957

(22) Filed: Feb. 15, 2008

(51) Int. Cl. G06F 7/04

(52) U.S. Cl. 726/17

(57) ABSTRACT

An automated method performed by a content host computer determines whether a client user is a human. A request for access to content residing on the content host computer is received from a client user. One or more advertising video clips are presented to the client user. An entire authenticating reference pass phrase is communicated to the client user in exactly one advertising video clip. An input passphrase is received from the client user. The input pass phrase is compared to the authenticating reference pass phrase. If the comparison shows identity, the client user is granted access to the requested content.

### FIELD

The present disclosure relates to CAPTCHA™ advertising, and is particularly directed to verifying that a content recipient is a human.

### BACKGROUND

The statements in this section merely provide background information related to the present disclosure and may not constitute prior art.

Today's content host computers typically determine whether a client user is a human by implementing a method generally known as a CAPTCHA™. A CAPTCHA™ is a type of challenge-response test used in computing to determine whether the user is human. CAPTCHA™ is a contrived acronym for “Completely Automated Public Turing test to tell Computers and Humans Apart”, trademarked by Carnegie Mellon University. The process involves one computer (a server) asking a user to complete a simple test which the computer is able to generate and grade, but not able to solve on its own. Because computers are typically unable to solve the CAPTCHA™, any user entering a correct solution is presumed to be human. A common type of CAPTCHA™ requires that the user type the letters of a distorted image, sometimes with the addition of an obscured sequence of letters or digits that appears on the screen. A CAPTCHA™ is sometimes described as a reverse Turing test because it is administered by a machine and targeted to a human. In contrast, a standard Turing test is typically administered by a human and targeted to a machine.

A CAPTCHA™ is used to prevent automated software from performing actions which degrade the quality of service of a given system, whether due to abuse or resource expenditure. Although a CAPTCHA™ is most often deployed as a response to encroachment by commercial interests, the notion that it exists to stop only spammers is mistaken. A CAPTCHA™ can be deployed to protect systems vulnerable to e-mail spam, such as webmail services. The CAPTCHA™ has also found active use in stopping automated posting to blogs or forums, whether as a result of commercial promotion, or harassment and vandalism. The CAPTCHA™ also serves an important function in rate limiting, as automated usage of a service might be desirable until such usage is performed in excess, and to the detriment of human users. In such a case, a CAPTCHA™ can enforce automated usage policies as set by the administrator when certain usage metrics exceed a given threshold. The article rating systems used by many news web sites are another example of an online facility vulnerable to manipulation by automated software.

There are a few approaches to defeating a CAPTCHA™: exploiting bugs in the implementation that allow the attacker to completely bypass the CAPTCHA™, improving character recognition software, or using cheap human labor to process the tests. A number of research projects have attempted (often with success) to beat a visual CAPTCHA™ by creating programs that contain the following functionality:

Extraction of the image from the web page;

Removal of background clutter, for example with color filters and detection of thin lines;

Segmentation, i.e. splitting the image into regions each containing a single letter; and

Identifying the letter for each region.

Steps 1, 2, and 4 are easy tasks for computers. The only part where humans still outperform computers is segmentation. If the background clutter consists of shapes similar to letter shapes, and the letters are connected by this clutter, the segmentation becomes nearly impossible with current software.

Some researchers promote the image recognition CAPTCHA™ as a possible alternative for a text based CAPTCHA™. To date, no major website has made use of an image based CAPTCHA™. As such, the technology would be best described as in the stage of theoretical research.

The image recognition CAPTCHA™ faces many potential problems which have not been fully studied. It is difficult for a small site to acquire a large dictionary of images to which an attacker does not have access. Without a means of automatically acquiring new labelled images, an image based challenge does not meet the definition of a CAPTCHA™. Some current image recognition examples of a CAPTCHA™ ask the user to make a binary choice (such as “Is this a cat or a dog?”). Even with just sixteen images, a bot has a 1 in 65536 chance of getting the image right every time. In order to be effective against a botnet attack, the user would be forced to solve a prohibitively large number of images. The disadvantage of a CAPTCHA™ based on static images is easy processability of the underlying images by computers as described above (automated character recognition, . . . ). On the other hand, present advertising on webpages has the major drawback that users simply close the advertising, employ advertising blocking programs or simply ignore the advertising.

### SUMMARY

An automated method performed by a content host computer determines whether a client user is a human. A request for access to content residing on the content host computer is received from a client user. One or more advertising video clips are presented to the client user. An entire authenticating reference pass phrase is communicated to the client user in exactly one advertising video clip. An input passphrase is received from the client user. The input pass phrase is compared to the authenticating reference pass phrase. If the comparison shows identity, the client user is granted access to the requested content.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is an entity relationship diagram illustrating a media content delivery system having a content host computer and an advertising server.

FIG. 2A is a flow diagram illustrating a method of operation for use with the content host computer of FIG. 1.

FIG. 2B is a flow diagram illustrating a method of operation for use with the advertising server of FIG. 1.

FIG. 3A is a swimlane diagram illustrating an example implementation of the methods of FIG. 2A and FIG. 2B, wherein the comparison of the pass phrase is performed on the content host computer of FIG. 1.

FIG. 3B is a swimlane diagram illustrating an example implementation of the methods of FIG. 2A and FIG. 2B, wherein the comparison of the pass phrase is performed on the central advertising server of FIG. 1.

### DETAILED DESCRIPTION

The following description is merely exemplary in nature and is not intended to limit the present disclosure, application, or uses.

The disclosed process implements a method for selectively allowing access for human client users to content stored on a remote server, while at the same time monetizing on the client user interaction. The automated method is at least in part performed by a content host computer for determining whether a client user is a human.

As used herein, the term “video clip” encompasses typical video clips as well as animated images. The term “pass phrase” encompasses input characters as well as actions performed by the user sufficient to clearly identify these actions and verify them on the server by comparison. These actions therefore may also encompass the selection of a certain object (e.g. button or image) on a web page by clicking. The content host computer may be understood to be comprised of one single computer or multiple computers, such as a server farm. The term “server” refers to the content host computer, if not indicated otherwise.

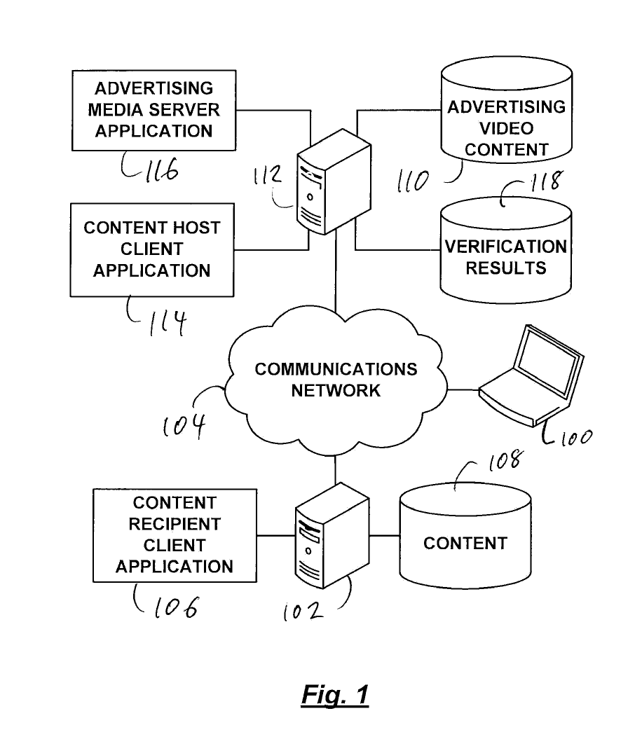

Beginning with FIG. 1, a method is provided for accepting access requests from a client device 100 connected to a content host computer 102 by a network 104, for example, the Internet and the World Wide Web. A widely distributed network of computers includes numerous client devices connected to server computers (e.g. content host computers) by a network, e.g., the Internet. Generally, the servers provide “Internet” services and products to users of the clients. The Internet includes an application interface called the World Wide Web (the “Web”). The computers communicate with each other using messages that include the addresses of the sending and receiving computers; these addresses are called Internet Protocol (IP) addresses.

The client devices can be personal computers, workstations, mobile phones, entertainment devices or laptops. Typically, the clients are equipped with input devices, such as a keyboard and a mouse, and output devices such as a loudspeaker and a display terminal. Software in the form of a Web browser, for example, the Firefox, or the Microsoft Internet Explorer, interacts with the I/O devices to provide an interface between the client user and the Web.

The server computers are usually larger computer systems, although this does not always need to be so. Some of the servers, e.g. web sites, maintain a database (DB), from which web pages may be generated. Each web page is identified and can be located by its name, e.g., a Uniform Resource Locator (URL). The pages can include “links” to other pages. A user can “click” on a link of a page viewed with the browser to retrieve a linked page.

Other servers maintain an index of the content of web pages. These servers are called search engines. Search engines accept search requests in the form of queries posed by users to locate Web pages having content on a specified topic. Some of the servers may provide other products and services that can be reached by using the browser.

Presume that the connection between the client and the server uses the Internet Protocol, and that the interactions between the client and the host computer are conducted using Web pages. The content host computer 102 supplies a content recipient client application 106 to the client device 100. This application 106 adapts the client device 100 to receive content supplied by content host computer 102. The content communicated by the content host computer 102 to the client device 100 includes content of datastore 108 that the user wishes to access. The content communicated by the content host computer 102 to the client device 100 also includes advertising video content of datastore 110.

The content host computer 102 receives an access request from the client device 100 via the network 104. In response, the content host computer 102 provides an advertising video clip, in which an authenticating reference pass phrase is communicated either visually or audibly to the human client user. The pass phrase is presented in a single (i.e., exactly one) video clip. Communicating the authenticating reference pass phrase to the human client user via an advertising video clip makes it impossible for present automated character recognition computer programs to guess the pass phrase.

One of the advertising video clips communicates the complete authenticating reference pass phrase to the user. The pass phrase is either communicated explicitly or associatively. As an example for the latter, a can of Coca-Cola® may be displayed and the user would be required to input the pass phrase “Coca-Cola”. On the other hand a pass phrase may be explicitly displayed in the video clip, e.g. “Coca-Cola” and the user might then be requested to click on a can of Coca-Cola® having the choice between different images or buttons. This has the particular advantage over some of the “puzzle-type” video clips or images and combine different syllables or characters to compose the pass phrase. The user needs to watch only one single advertising video clip carefully enough, so that the user recognizes the pass phrase and returns the pass phrase to the content host computer using an appropriate input device such as a keyboard. In contrast to some prior art embodiments the user does not need to memorize the pass phrase in the present invention.

Presenting the passphrase in advertising video clips instead of other video clips is that the user needs to pay close attention to the advertising video clip in order to gain access to the requested content. This way, the user cannot use advertising blocking programs, close the advertising or ignore the advertising, if the user wants to gain access to the requested content. Further, the user can immediately recognize the pass phrase and does not need a mental leap to arrive at the pass phrase. Additionally, easier recognition of the pass phrase by the user in the advertising video clip is accomplished compared to the CAPCHAS™ of the prior art, in which the pass phrase is heavily distorted and sometimes illegible. Also, the website owner or operator of the content host computer has the advantage of generating additional revenue. Yet further, advertising impact is dramatically enhanced, since the user needs to watch the advertising video clip carefully to answer the corresponding question or entering the correct pass phrase. By entering the correct pass phrase the advertising message is retained in the user's memory, since the user needs to deal with the advertising message actively.

The content host computer 102 renders the advertising video clip on an output device, such as a display terminal, of the client device 100. In response, the client device 100 sends the pass phrase as input (e.g. typed in) by the user to the content host computer 102. Hopefully, the answer is the user's guess for the correct answer. The content host computer 102 determines if the guess is the correct answer. In some embodiments, the content host computer performs this determination by comparing the answer with the authenticating reference pass phrase. In other embodiments, the content host computer 102 sends the passphrase to advertising server 112, which performs the comparison and reports the results to the content host computer 102.

If the answer is correct, then the content host computer 102 accepts the access request. If the correct answer is not received within a predetermined amount of time or after a certain amount of input attempts, the connection between the user client device 100 and content host computer 102 is terminated by the content host computer 102 on the assumption that an automated agent is operating in the client device 100 on behalf of the user.

In some embodiments, advertising server 112 supplies a content host client application 114 to the content host computer 102 in order to adapt the content host computer 102 to implement the aforementioned process. The advertising server also executes an advertising media server application 116 in order to interact with the content host computer 102. This interaction includes logging incidences of successful verification of advertising content to human users. The incidences are logged in verification results datastore 118.

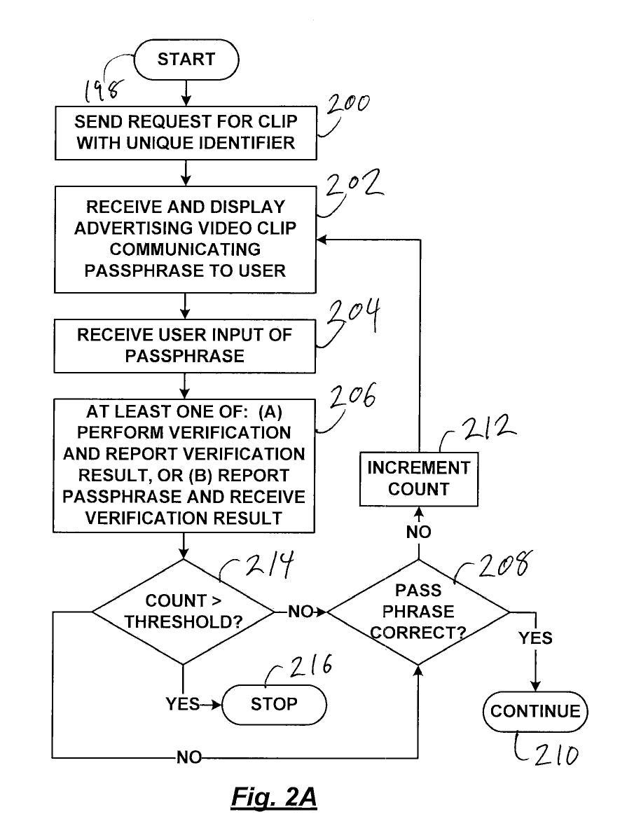

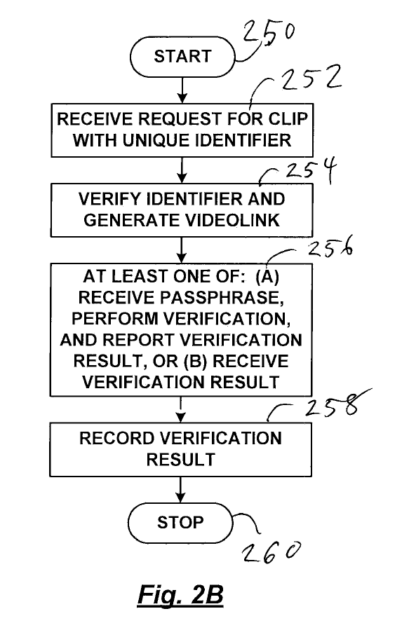

Turning now to FIG. 2A, a method of operation for use with a content host computer begins at 198 in response to a request by a user for content. Then, at step 200, the content host computer sends a request for an advertising clip to the advertising server. The request includes a unique identifier. This identifier communicates identity of the user so that user activity is tracked, and advertising clips are delivered accordingly. In other words, a user is not presented the same advertising clip over and over, but is presented with different clips. Alternatively, the user is intentionally presented with the same advertising clip numerous times.

The request is for a particular advertiser or set of advertisers that supply remuneration in exchange for successful delivery of their advertising video clips to users. The request is formulated based on the content requested by the user. In other words, the advertisers host specific content, and the advertisement video clips are delivered to users requesting that content. As a result, the advertising video clips are directed to users having a particular interest in the content, which allows advertisers to target users by user interest.

Next, the content host computer receives and displays the advertising video at step 202 by employing the client device. The video clip includes a pass phrase in video form as part of the advertising content. In some embodiments, the video additionally instructs the user to input the passphrase. In alternative or additional embodiments, the content host computer employs the client device to instruct the user to input the passphrase. Next, the content host computer receives the user input of the passphrase at step 204.

Upon receipt of the passphrase, the content host computer performs one of two procedures at step 206. In some embodiments, the content host computer performs verification of the passphrase and reports the verification result to the advertising server. In this case, the content host computer additionally receives criteria for verifying the passphrase from the advertising server at step 202. In other embodiments, the content host computer reports the passphrase to the advertising server for verification, and receives the verification result from the advertising server. Then, if the verification result indicates that the passphrase was correct at 208, then the content host computer continues at 210 by granting the user access to the content requested by the user. Otherwise, a count variable is incremented at step 212, and processing returns to step 202, at which the video clip is again presented to the user. Thereafter, if the count variable is determined to exceed a predetermined threshold at decision step 214, then processing stops at 216, which effectively bars the user from accessing the requested content.

Turning now to FIG. 2B, a method of operation implemented by an advertising server begins at step 250 with receipt of a request for an advertising clip. The request has the unique identifier discussed above. The advertising server next verifies the identifier and generates a videolink for the content host computer to receive the requested advertising content at step 252.

At step 256, the advertising server performs one of two processes. In some embodiments, the advertising server receives the user-input passphrase from the content host computer, performs verification of the user-input passphrase, and reports the verification result to the content host computer. In other embodiments, the advertising server simply receives the verification result from the content host computer. Upon obtaining the verification result, the advertising server records the result in a computer readable medium at step 258. Recording the result facilitates payment for the advertising by the advertising buyer corresponding to the presented advertising video clip. The process ends at 260.

It should be readily understood that additional or alternative embodiments of the aforementioned system, methods, and processors can implement additional or alternative procedures. Also, some of the procedures can be omitted in some embodiments. For example, in some embodiments, the client device can request the video clip directly from the advertising server, which can then perform the verification and notify the content host computer of the result. Also, in some embodiments, the client device can communicate the passphrase directly to the advertising server. Further, it should be understood that the processes can be modified for a peer to peer implementation.

The disclosed methods are useful to prevent automated programs from entering unwanted information or comments in blogs, guest books or other website applications. For this purpose, the method can be implemented as a plug-in for content management systems. People maintaining blogs (bloggers) have the additional benefit of a new revenue source.

E-commerce portals can also use the disclosed methods to generate additional revenue, such as to lower shipping costs. Also, highly targeted advertising can be shown to specific users featuring specific products. As an example, in a situation where a user purchases a drilling machine, the advertising video clip of the present invention can feature a buzz saw of the same manufacturer.

Preferably, the advertising video clip is served from a central advertising server and is not residing on the content host computer. For example, the content host computer can embed suitable code into a webpage to display the advertising video clip residing on the central advertising server. This can be achieved by simply embedding and referencing an external video clip (e.g. a Flash movie) or by using a special plugin-software, as typically used by blog-software such as Wordpress. It is also possible to generate appropriate code using server side scripting (e.g. PHP or ASP) to display the advertising video clip residing on the central advertising server as part of the webpage hosted on the content host computer.

In some embodiments, the advertising video clip is transferred to the client user using a temporarily created filename, which is streamed from the original filename, under which the advertising video clip is stored on the central advertising server. The central advertising server stores the advertising videos using a mostly unchangeable filename for easy reference and clear mapping. To prevent an automated program from guessing the correct filename of an advertising video clip communicating a particular authenticating reference pass phrase, a filename used to transfer the advertising video clip to the content host computer or the client device is temporarily created for each single time that the method according to the invention is employed. The temporary filename and the server side filename on the central advertising server are preferably mapped in a database table for reference lookup.

Preferably, the content host computer presents a typical CAPTCHA™ with an authenticating reference pass phrase to the user, in case the connection to the central advertising server cannot be established. The plugin or server side script on the content host computer can lose connection with the central advertising server. But it will still protect the requested content from automatic access by computer programs by employment of a typical CAPTCHA™ and process it accordingly.

Preferably, the comparison is performed on the central advertising server. This ensures that the true authenticating reference pass phrase does not have to leave the central advertising server and therefore is more secure against fraudulent attacks. As discussed above, the content host computer can send the pass phrase as received by the client user over the network to the central advertising server, which in turn compares the pass phrase as received by the user with the authenticating reference pass phrase and sends the result of the comparison back to the content host computer. The content host computer can then decide to grant access or deny access to the requested content based on the reply of the central advertising server.

As mentioned above, a user identification code is transmitted from the content host server to the central advertising server. Many content host computers host web applications, in which users are required to log in and leave personal details. These users are identified by their respective user log in information. A unique user identification code is transmitted to the central advertising server together with the pass phrase as received by the user. This identifier allows the central advertising server to capture the frequency of a particular user's visits to certain websites. It also allows the advertising server to deliver advertising videos based on the user behavior and interest. With this kind of user information at hand it is possible to serve a particular advertising video clip to a particular user in more or less predetermined intervals. Where no user details are available from the content host computer, no user identification code or a randomly generated user identification code is transmitted.

The identity of the advertising video clip is determined by the central advertising server. For example, according to the captured user behavior by the central advertising server as described above, a certain advertising video clip with its associated authenticating reference pass phrase may be served and ultimately delivered to the client user. The advertising video clip is chosen based on the purchasing behavior of the advertising buyer. A certain advertising buyer pays a certain amount of money to have his advertising video clip displayed a certain number of times within a certain period of time, preferably even to a certain user. Payment for the advertising by the advertising buyer corresponding to the presented advertising video clip is achieved by billing the advertising buyer for each displayed advertising video clip.

In some embodiments, access is denied to the requested content, if comparison does not show identity, and a different advertising video clip with a different authenticating reference pass phrase is presented to the client user. In other words, if the client user has entered the wrong pass phrase, a different advertising video clip with a different authenticating reference pass phrase may be presented to the client user. In this case, a new, different clip is requested, and the user identity ensures that the advertising server knows to present a different advertising clip to the user.

In some embodiments, the user is credited with money or virtual currency for each successful input of the pass phrase. Thus, the disclosed method is used as a payment system, especially for low priced goods or services. In a particular example, the user is required to type in a pass phrase after having seen an advertising video clip, and is rewarded with a download of a music file (e.g. MP3-file). In another example, the user is credited with virtual currency for each successful input of the pass phrase; the accumulated virtual currency is redeemable at a later point of time for real money or goods or services.

In a further example, the user is subsequently be allowed to use a software program, email interface or to buy goods or services. This advertising method is especially effective for shareware programs or free to use email services. In a preferred embodiment, the disclosed method is a pay-per-use model, where the user has to perform the method instead of money payment for use of the software. If the user input is correct when compared with the pass phrase, the user is granted access to the service or software program. This business model is applied during an entire lifetime of the software program or service, either as an exclusive or partial revenue source. The business model may also be just applied until the user purchases the full version of the software program or full membership of a service.

As another example, the method is used in connection with social networks. These networks so far use a regular CAPTCHA™ to prevent fraudulent use by automated programs. These fraudulent programs are able to add “friends” automatically and leave unwanted messages or entries in guestbooks. In addition, there is the danger that personal information of users is stored and used against their will. As already described above, the disclosed method prevents these fraudulent programs from accessing content automatically.

As a further example, the method according to the present invention, and in particular above mentioned preferred pay-per-use model, is employed in the download of music files (e.g. MP3 files). The revenue generated by the method is used to pay for the music files or at least subsidize the purchase of the music files. Additional benefit is seen in the image transfer of the advertising buyers having their advertising video clip displayed prior to the download of music files of particular artists or songs. The same is applied to On-Demand-Movie portals or downloadable ring tones.

As still another example, low priced goods or services are financed through the use of the disclosed method. As an example, online articles of newspapers are made available after having performed the method. In other words, users do not have use micropayment systems.

As yet a further example, the disclosed method invention is also employed for gaming or betting portals. The users also have to perform the disclosed method to earn their wager or start money. Earning or redeeming comps in casinos are also conditioned on successful completion of the disclosed method.

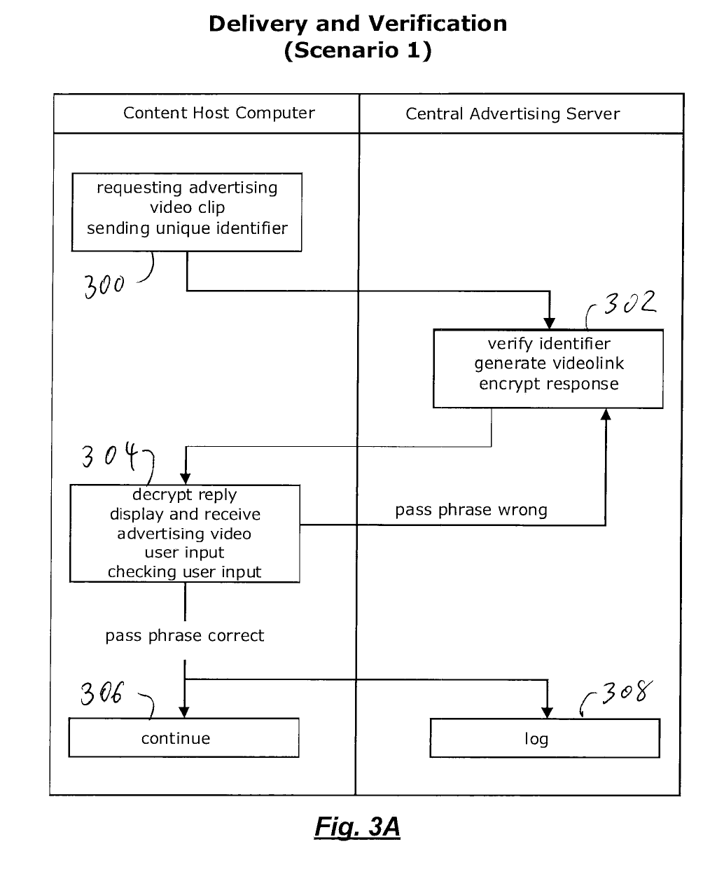

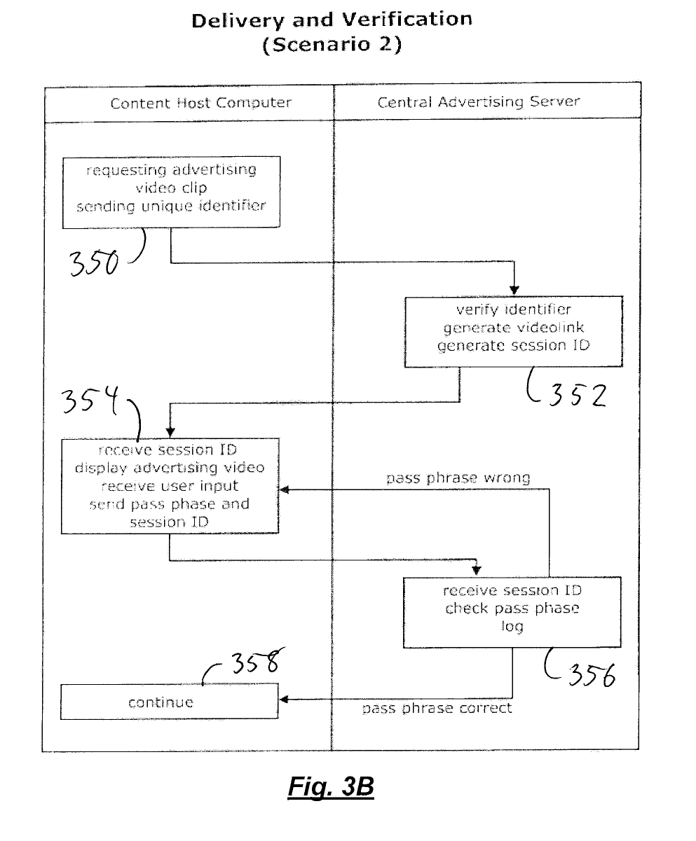

Turning now to FIG. 3A, an example implementation performs comparison of the pass phrase on the content host computer. In a first step 300, the content host computer requests an advertising video clip from the central advertising server and sends a unique identifier. As a response, the central advertising server verifies the unique identifier, generates a link to the advertising video (videolink), and sends the encrypted response to the content host computer at step 302. At step 304, the content host computer then decrypts the reply, receives and displays the advertising video clip, gets the user input, and checks the user input by comparison as described above. In case the pass phrase is wrong, the content host computer requests another advertising video clip. Otherwise, the user is allowed to continue at step 306 (e.g. access to the requested content). At the same time, the procedure is logged at step 308 (e.g. in a log file or database) by the central advertising server.

Turning now to FIG. 3B, another embodiment performs comparison of the pass phrase on the central advertising server. In a first step 350, the content host computer requests an advertising video clip from the central advertising server and sends a unique identifier. As a response at step 352, the central advertising server verifies the unique identifier and generates a link to the advertising video (videolink) and generates a session identifier (session ID). At step 354, the content host computer next receives the session identifier and facilitates display of the advertising video clip on the client device (e.g., streaming the advertising video clip to the client device). At step 354, the content host computer also receives the user input and sends the pass phrase together with the session identifier to the central advertising server. The central advertising server then checks the pass phrase at step 356 by comparison as described above and, upon success, lets the user access the originally requested content at step 358. In case of a wrong input of the pass phrase by the user, the central advertising server generates a new videolink and lets the content host computer stream a new advertising video clip to the client device.

In a specific example of use, a client user requests a certain webpage residing on the content host computer. The content host computer receives this request and presents exactly one advertising video clip named “filenameA.swf” to the client user. This advertising video clip has been embedded with simple HTML code in the webpage. This code references the advertising video clip named “filenameA.swf” residing on the central advertising server with a typical uniform resource locator (URL). The advertising video clip plays back as it is streamed to the client user. For example, the advertising video clip shows people being excited about a new product called “CAPTCHAAD” and hold up a big and clearly legible sign reading “CAPTCHAAD”. The user reads this pass phrase and types it into a text input form shown below the rendered advertising video clip and submits the form.

After having received the pass phrase as input from the user, the content host computer sends this pass phrase as received to the central advertising server over the Internet. The central advertising server compares the input pass phrase with the stored authenticating reference pass phrase and finds identity between both. The central advertising server sends this result back to the content host computer, which then in turn grants access to the requested content and facilitates payment for the advertising by the advertising buyer corresponding to the presented advertising video clip.

The transmitted file with the temporary filename “filenameA.swf” for the advertising video clip is stored on the central advertising server under the permanent filename “CAPTCHAAD.swf”. To be able to map the temporary filename to the permanent filename, the central advertising server maintains a database with a lookup table having at least two fields for the temporary filename and the permanent filename. To keep track of user behavior, an additional table is employed to store the time and date of the last visit of a particular user together with the user identification code, the name of the content host server, the internal, and the permanent filename of the advertising video clip.

What is claimed is:

1. An automated method performed by a content host computer for determining whether a client user is a human, the method comprising:
receiving from a client user a request for access to content residing on the content host computer;
presenting at least one advertising video clip to the client user, wherein an entire authenticating reference pass phrase is communicated to the user in exactly one advertising video clip;
receiving as input from the user a pass phrase;
making a comparison of the pass phrase as received by the user to the authenticating reference pass phrase; and
if the comparison shows identity, granting access to the requested content.

2. The method of claim 1, wherein the advertising video clip is served from a central advertising server and is not residing on the content host computer.

3. The method of claim 2, wherein the advertising video clip is streamed to the client user using a temporarily created filename, which is different from an original filename under which the advertising video clip is stored on the central advertising server.

4. The method of claim 2, in wherein the content host computer, in case the connection to the central advertising server cannot be established, presents a typical CAPTCHA™ with an authenticating reference pass phrase to the user.

5. The method of claim 2, wherein the comparison is performed on the central advertising server.

6. The method of claim 2, wherein a user identification code is transmitted from the content host server to the central advertising server.

7. The method of claim 1, wherein, if the comparison does not show identity, access is denied to the requested content and a different advertising video clip with a different authenticating reference pass phrase is presented to the client user.

8. The method of claim 1, wherein the client user is a mobile phone.

9. The method of claim 1, wherein the client is a personal computer.

10. The method of claim 2, wherein an identity of the advertising video clip is determined by the central advertising server.

11. The method of claim 1, wherein the client user is credited with at least one of money or virtual currency for each successful input of the pass phrase.

12. The method of claim 1, wherein the user is subsequently allowed, conditioned on the granting of the access, to at least one of use a software program, use an email interface, or buy goods or services.

13. The method of claim 1 further comprising, if the comparison shows identity, facilitating payment by an advertising buyer for successful delivery of the advertising video clip.

14. An advertising clip delivery system, comprising:
a content datastore containing electronic content data;
content delivery module receiving a request for the advertising content data from a client device over a communications network;
an advertising video clip delivery module employing an output of the client device to present an advertising video clip, wherein an entire authenticating reference pass phrase is presented in exactly one advertising video clip;
an advertisement video delivery verification module receiving an input passphrase from the client device and making a comparison of the passphrase to the authenticating reference passphrase,
wherein said content delivery module delivers the electronic content data to the client device contingent on the comparison ascertaining a successful match between the passphrase and the authenticating reference passphrase.

15. The system of claim 14, further comprising a content host computer and an advertising server having an advertising video clip datastore, wherein said advertising server receives a request for the advertising video clip and communicates the advertising video clip to said advertising content delivery module.

16. The system of claim 15, wherein:
said content host computer includes said a content datastore, said content delivery module, and said advertising video clip delivery module; and
said advertising server includes said advertisement video delivery verification module.

17. The system of claim 14, further comprising a an advertising buyer payment facilitation module logging data concerning results of the comparison in a computer readable medium.

18. A content host computer, comprising:
a computer readable medium recording electronic content data;
an input port receiving a request for the electronic content data from a client device over a communications network;
an output port sending one or more advertising video clips to the client device over the communications network, wherein an entirety of an authenticating reference passphrase is presented in exactly one of the advertising video clips, wherein said input port receives a passphrase from the client device; and
a computer processor executing machine code instructions in computer memory, wherein the machine code instructions operatively connect said computer readable medium, said input port, and said output port to grant the client device access to the electronic content data contingent on results of a verification indicating a successful match of the passphrase to the authenticating reference passphrase.

19. The content host computer of claim 18, wherein the machine code instructions perform the verification by matching the passphrase to the authenticating reference passphrase.

20. The content host computer of claim 18, wherein the machine code instructions employ said input port and said output port to transmit the passphrase over the communications network to an advertising server and receive a response from the advertising server indicating the results of the verification performed by the advertising server.

21. An advertising server, comprising:
a computer readable medium recording advertising video clips;
an input port receiving a request for one or more advertising video clips from a requester;
an output port communicating the advertising video clips to the requester, wherein an entirety of an authenticating reference passphrase is presented in exactly one of the advertising video clips; and
a computer processor executing machine code instructions in a computer memory, wherein said machine code instructions operatively connect said computer readable medium, said input port, and said output port to process the request and to record in said computer readable medium results of a verification indicating a successful match of the authenticating reference passphrase to a passphrase supplied by a user of a client device by which the advertising video clips are presented to the user.
